(19) United States
(12) Patent Application Publication
(10) Pub. No.: US 2014/0002322 A1
(43) Pub. Date: Jan. 2, 2014

(54) SHIELD CABLE, MANUFACTURING METHOD OF THE SHIELD CABLE, AND WIRELESS COMMUNICATION MODULE

(71) Applicant: CANON COMPONENTS, INC., Kodama-gun (JP)

(72) Inventors: Osamu KANOME, Saitama (JP); Hironobu MIZUNO, Saitama (JP); Yoshihiro HATTORI, Saitama (JP)

(21) Appl. No.: 13/930,907

(22) Filed: Jun. 28, 2013

(30) Foreign Application Priority Data
Jun. 29, 2012 (JP) 2012-147334

(51) Int. Cl. H01B 11/00; H01Q 1/48; H01B 13/22; H01Q 1/50

(52) U.S. Cl. CPC H01B 11/00; H01Q 1/50; H01Q 1/48; H01B 13/22
USPC 343/848; 174/107; 343/905; 29/825

(57) ABSTRACT

A shield cable includes: a first film member made of an insulating resin; a second film member made of an insulating resin; a laminated body including a center conductor surrounded by the first film member and the second film member; an easy-adhesion layer positioned around the laminated body; an outer conductor positioned around the easy-adhesion layer; and a protective film that covers around the outer conductor, wherein the shield cable is flat when viewed in cross section.

### CROSS-REFERENCE TO RELATED APPLICATIONS

This application is based upon and claims the benefit of priority of the prior Japanese Patent Application No. 2012-147334, filed on Jun. 29, 2012, the entire contents of which are incorporated herein by reference.

### BACKGROUND OF THE INVENTION

1. Field of the Invention

The present invention relates to a shield cable used in a transmission line unit of a high frequency signal, a manufacturing method of the shield cable, and a wireless communication module using the shield cable that can be mounted on a communication device.

2. Description of the Related Art

In recent years, reduction in dimension and thickness is demanded in wireless communication modules mainly used for communication devices, such as mobile phones, digital cameras, printers, and other mobile devices, and accurate arrangement in the housings of the communication devices is also demanded. Therefore, not only satisfaction of electromagnetic specifications, such as electromagnetic shielding capability and characteristic impedance, is demanded in transmission lines connecting high frequency (RF) circuits and antennas included in the wireless communication modules, but a flexible mounting property and a reduced space property are also demanded.

An example of a coaxial cable with a small diameter used as a transmission line includes a coaxial cable with an outer shape of 150 μm or smaller disclosed in Patent Document 1, wherein an outer conductor is formed by using metal nanoparticles.

An example of a technique for reducing the dimension of a wireless communication module includes a strip line cable disclosed in Patent Document 2, wherein an antenna unit and a transmission line unit are integrated.
Patent Document 1: Japanese Laid-open Patent Publication No. 2009-123490
Patent Document 2: Japanese Laid-open Patent Publication No. 08-242117

### SUMMARY OF THE INVENTION

When the coaxial cable disclosed in Patent Document 1 is used for a transmission line of a wireless communication module in which the reduction in the dimension and thickness is demanded, it is difficult to reduce the space, because the coaxial cable has a limit in bending at a small radius of curvature. A dedicated connector is necessary to connect the coaxial cable to an antenna or a high frequency circuit. This leads to an increase in the number of components, and it is difficult to reduce the space. Furthermore, the connector causes a return loss (transmission loss) at a connection point.

To improve the shielding capability of the strip line cable disclosed in Patent Document 2, an outer conductor of the cable is formed by additionally applying a conductive paste or attaching a metal foil to a side wall between front and back surfaces on which GND conductors are disposed, thereby covering the entire cable by an insulating film. The adhesiveness between the added conductor and the side surface is low in the cable, and the bondability between the GND conductors and the added conductor is low. Therefore, the outer conductor may be damaged or deformed when the cable is bent, and there is a problem that the reliability of communication is reduced.

The present invention has been made in view of the problems, and an object of the present invention is to provide a shield cable that can ensure reliability of communication and that can be arranged in a reduced space. Another object of the present invention is to provide a wireless communication module with reduced dimension and thickness as well as a degree of freedom in the arrangement in the housing of a communication device.

The present invention provides a shield cable including: a laminated body including: a first film member made of an insulating resin; a second film member made of an insulating resin; and a center conductor surrounded by the first film member and the second film member; an easy-adhesion layer positioned around the laminated body; an outer conductor positioned around the easy-adhesion layer; and a protective film that covers around the outer conductor, wherein the shield cable is flat when viewed in cross section.

The present invention provides a manufacturing method of a shield cable, the manufacturing method including: a step of manufacturing a laminated body by placing a center conductor between a first film member made of an insulating resin and a second film member made of an insulating resin; a step of forming an outer conductor around the laminated body; and a step of covering around the outer conductor by a protective film.

The present invention provides a wireless communication module including: the shield cable; an antenna unit including an antenna element to which the center conductor of the shield cable is extended and connected; and a high frequency circuit unit including a circuit conductor to which the center conductor of the shield cable is extended and connected.

### BRIEF DESCRIPTION OF DRAWINGS

FIG. 1 is a plan view of a wireless communication module of the present embodiments;

FIG. 2 is a sectional view of a shield cable of a first embodiment;

FIG. 3A is a view illustrating a manufacturing method of the shield cable of the first embodiment;

FIG. 3B is a view illustrating the manufacturing method of the shield cable of the first embodiment;

FIG. 3C is a view illustrating the manufacturing method of the shield cable of the first embodiment;

FIG. 3D is a view illustrating the manufacturing method of the shield cable of the first embodiment;

FIG. 3E is a view illustrating the manufacturing method of the shield cable of the first embodiment;

FIG. 3F is a view illustrating the manufacturing method of the shield cable of the first embodiment;

FIG. 3G is a view illustrating the manufacturing method of the shield cable of the first embodiment;

FIG. 3H is a view illustrating the manufacturing method of the shield cable of the first embodiment;

FIG. 3I is a view illustrating the manufacturing method of the shield cable of the first embodiment;

FIG. 4A is a view illustrating a manufacturing method of a shield cable of a second embodiment;

FIG. 4B is a view illustrating the manufacturing method of the shield cable of the second embodiment;

FIG. 4C is a view illustrating the manufacturing method of the shield cable of the second embodiment;

FIG. 4D is a view illustrating the manufacturing method of the shield cable of the second embodiment;

FIG. 4E is a view illustrating the manufacturing method of the shield cable of the second embodiment;

FIG. 4F is a view illustrating the manufacturing method of the shield cable of the second embodiment;

FIG. 4G is a view illustrating the manufacturing method of the shield cable of the second embodiment;

FIG. 4H is a view illustrating the manufacturing method of the shield cable of the second embodiment;

FIG. 4I is a view illustrating the manufacturing method of the shield cable of the second embodiment;

FIG. 5A is a view illustrating a manufacturing method of a shield cable of a third embodiment;

FIG. 5B is a view illustrating the manufacturing method of the shield cable of the third embodiment;

FIG. 5C is a view illustrating the manufacturing method of the shield cable of the third embodiment;

FIG. 5D is a view illustrating the manufacturing method of the shield cable of the third embodiment;

FIG. 5E is a view illustrating the manufacturing method of the shield cable of the third embodiment;

FIG. 5F is a view illustrating the manufacturing method of the shield cable of the third embodiment;

FIG. 5G is a view illustrating the manufacturing method of the shield cable of the third embodiment;

FIG. 5H is a view illustrating the manufacturing method of the shield cable of the third embodiment;

FIG. 5I is a view illustrating the manufacturing method of the shield cable of the third embodiment;

FIG. 6A is a view illustrating a manufacturing method of a shield cable of a fourth embodiment;

FIG. 6B is a view illustrating the manufacturing method of the shield cable of the fourth embodiment;

FIG. 6C is a view illustrating the manufacturing method of the shield cable of the fourth embodiment;

FIG. 6D is a view illustrating the manufacturing method of the shield cable of the fourth embodiment;

FIG. 6E is a view illustrating the manufacturing method of the shield cable of the fourth embodiment;

FIG. 6F is a view illustrating the manufacturing method of the shield cable of the fourth embodiment;

FIG. 6G is a view illustrating the manufacturing method of the shield cable of the fourth embodiment;

FIG. 6H is a view illustrating the manufacturing method of the shield cable of the fourth embodiment;

FIG. 6I is a view illustrating the manufacturing method of the shield cable of the fourth embodiment;

FIG. 6J is a view illustrating the manufacturing method of the shield cable of the fourth embodiment;

FIG. 7 is a plan view of a wireless communication module of a fifth embodiment;

FIG. 8 is a sectional view of the wireless communication module of the fifth embodiment;

FIG. 9 is a sectional view of the wireless communication module of a sixth embodiment;

FIG. 10 is a view illustrating the shield cable bent in a thickness direction; and

FIG. 11 is a view illustrating an internal configuration of the shield cable.

### DETAILED DESCRIPTION OF THE PREFERRED EMBODIMENTS

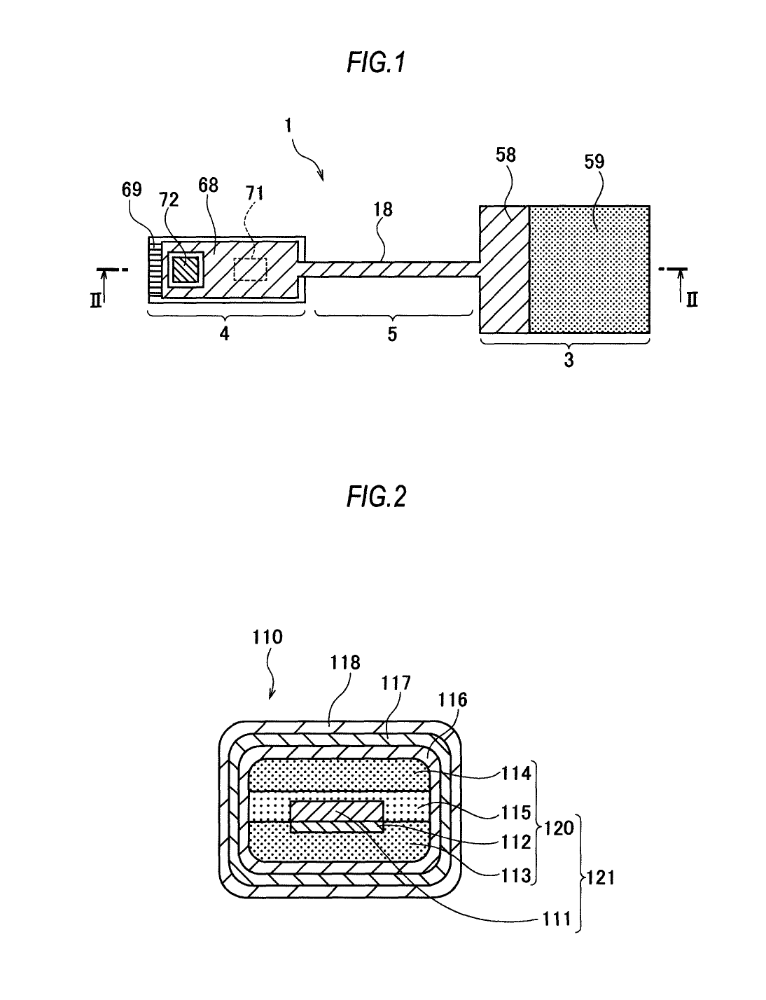

FIG. 1 is a plan view illustrating an example of a wireless communication module 1 manufactured by using a transmission line unit 5 (shield cable) according to any one of first to fourth embodiments of the present invention. Although the shield cable is bent to house the wireless communication module 1 in a reduced space in the housing of a communication device, the shield cable is expanded and illustrated in a flat shape in FIG. 1.

The wireless communication module 1 is compatible with short-distance wireless communication. The wireless communication module 1 includes: a high frequency circuit unit 4 that processes a high frequency signal; an antenna unit 3 that transmits and receives an electromagnetic wave of the high frequency signal; and the shield cable as the transmission line unit 5 that transmits the high frequency signal between the high frequency circuit unit 4 and the antenna unit 3.

Electronic components 71 and 72 are mounted on the high frequency circuit unit 4. The high frequency circuit unit 4 includes an external connection electrode 69 at an end and is provided with a protective film 68 on the surface. The antenna unit 3 is provided with an antenna protective member 59 and is provided with a protective film 58 partially extending on the surface from the shield cable.

Shield cables according to the present invention will be described in detail in the first to fourth embodiments, and wireless communication modules manufactured by using any of the shield cables will be described in detail in fifth and sixth embodiments.

### First Embodiment

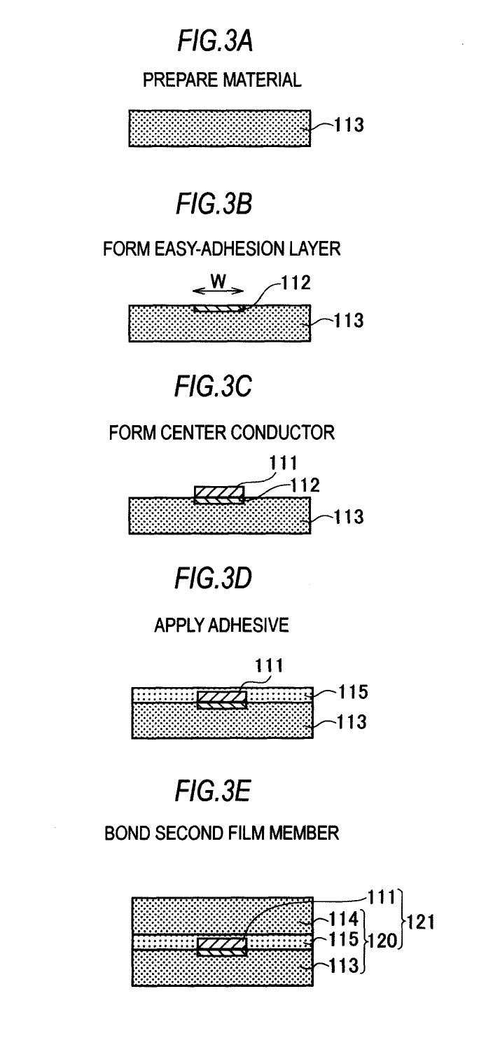

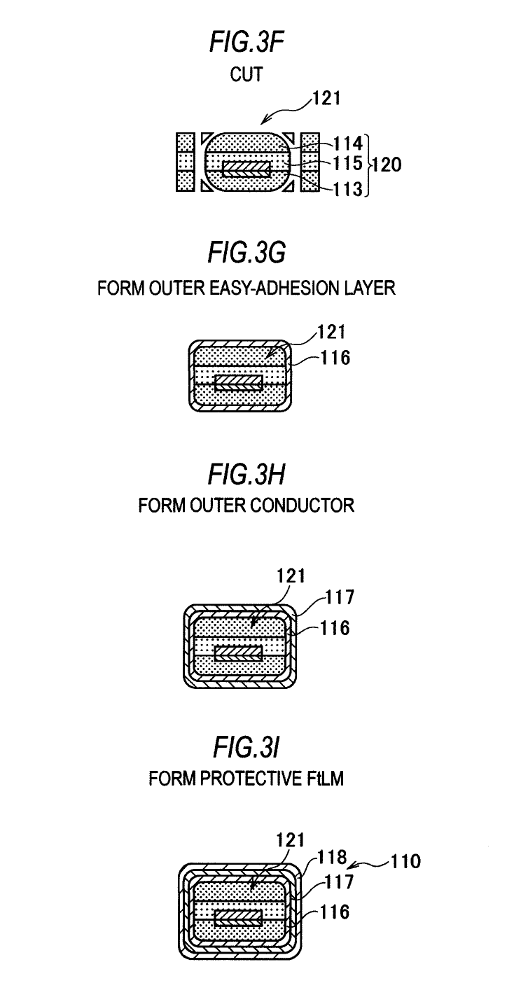

A structure and a manufacturing method of a shield cable 110 according to the first embodiment will be described with reference to FIGS. 2 and 3. FIG. 2 is a sectional view of the shield cable 110 cut in a direction orthogonal to a longitudinal direction. In the shield cable 110, a center conductor 111 formed by copper foil is surrounded by an internal dielectric 120, an outer easy-adhesion layer 116 formed by surface treatment is positioned around the internal dielectric 120, an outer conductor 117 formed as a shield is positioned around the easy-adhesion layer 116, and a protection film 118 further covers around the outer conductor 117.

The manufacturing method of the shield cable 110 will be described with reference to FIGS. 3A to 3I. FIGS. 3A to 3I are views illustrating a series of manufacturing steps of the shield cable 110.

(1-A) A polyimide film that is an insulating resin in an A4 size with a thickness of 25 μm is prepared as a first film member 113 (FIG. 3A).

(1-B) A nickel exposure mask with openings in a shape of the center conductor (mask with a plurality of openings with a width of 70 μm and a length of 200 mm) is closely attached to one of the surfaces of the first film member 113, and UV light (ultraviolet light) is applied for 5 minutes by a low-pressure mercury lamp to form an easy-adhesion layer 112 as a surface-modified layer (FIG. 3B). The width denotes an arrow W direction illustrated in FIG. 3B, and the length denotes a perpendicular direction on the paper in FIG. 3B.

(1-C) The center conductor 111 is formed by applying electroless copper plating to copper over the easy-adhesion layer 112 until the thickness is approximately 1 μm (FIG. 3C). As a result of this step, the center conductor 111 is closely attached to the first film member 113 through the easy-adhesion layer 112. The openings of the nickel exposure mask form the pattern shape of the center conductor 111. A method similar to a plating method disclosed in Japanese Laid-open Patent Publication No. 2000-212762 can be used for the process of electroless plating.

(1-D) Polyamic acid as an adhesive layer 115 is applied on the surface of the first film member 113 provided with the center conductor 111 (FIG. 3D).

(1-E) The same polyimide film as the first film member 113 is bonded as a second film member 114 over the applied adhesive layer 115. More specifically, the center conductor 111 is placed between the first film member 113 and the second film member 114. A laminated body 121 is manufactured by heating and laminating at 250° C. (FIG. 3E).

(1-F) The laminated body 121 is cut parallel to the longitudinal direction of the center conductor 111, at positions 30 μm away from both ends of the center conductor 111 in the width direction. Corners of the cut laminated body 121 are trimmed in a curved shape (R face), and the shape is smoothed (FIG. 3F). As a result of this step, the laminated body 121 in a flat shape including the center conductor 111 surrounded by the internal dielectric 120 consisting of the first film member 113, the second film member 114, and the adhesive layer 115 is manufactured.

(1-G) The UV light is applied for 5 minutes to the entire surface of the outer periphery of the laminated body 121 to form the outer easy-adhesion layer 116 (FIG. 3G).

(1-H) A method similar to the method of forming the center conductor 111 in (1-C) is used to seamlessly form the outer conductor 117 throughout the entire surface of the outer periphery of the easy-adhesion layer 116 (FIG. 3H). As a result of this step, the outer conductor 117 is closely attached around the laminated body 121 through the easy-adhesion layer 116.

(1-I) A vinyl resin is applied to the entire surface of the outer periphery of the outer conductor 117 to form the protective film 118 with a thickness of approximately 10 μm (FIG. 3I). The center section of the shield cable 110 in the longitudinal direction is cut in a length of 180 mm. The outer shape of the manufactured shield cable 110 is a flat shape in which the thickness×width is approximately 70 μm×150 μm. The characteristic impedance of the shield cable 110 is designed to be approximately 50 Ω.

A flexural test is conducted for the manufactured shield cable 110. The flexural test is a test for confirming the bending anisotropy when the shield cable 110 is bent in the width direction and the thickness direction. As a result of the test, it is clear that the shield cable 110 is more easily bent in the thickness direction than in the width direction, and the bending anisotropy can be confirmed.

A bending test is conducted 100 times for the manufactured shield cable 110. The bending test is a test of bending the shield cable 110 in the thickness direction from 0° to 90° at a predetermined section. As a result of the test, there is no break or the like in the shield cable 110, and sufficient reliability can be confirmed.

Since the shield cable 110 is extremely thin and flat, the shield cable 110 can be bent at an extremely small radius of curvature in the thickness direction and can be arranged in a reduced space in the housing of a communication device.

FIG. 10 is a view illustrating the shield cable 110 bent in the thickness direction.

### Second Embodiment

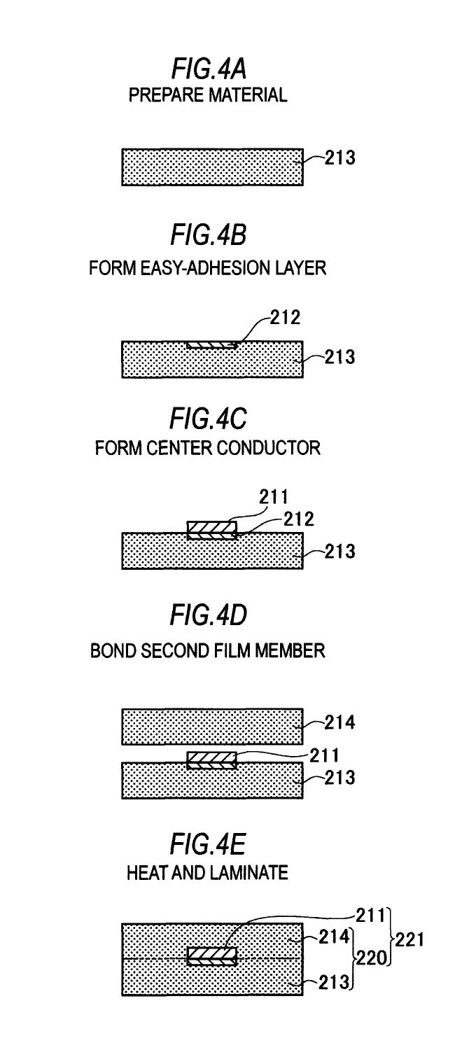

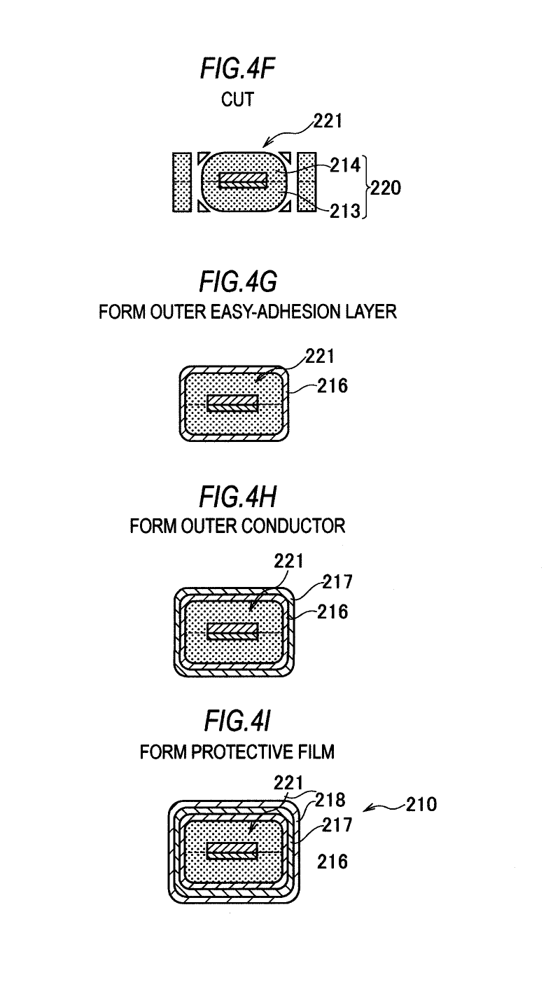

A structure and a manufacturing method of a shield cable 210 according to the second embodiment will be described with reference to FIG. 4A to 4I.

FIGS. 4A to 4I are views illustrating a series of manufacturing steps of the shield cable 210.

(2-A) A cyclo-olefin polymer film (hereinafter, called “COP film”) that is an insulating resin in an A4 size with a thickness of 50 μm is prepared as a first film member 213 (FIG. 4A).

(2-B) A nickel exposure mask with a plurality of openings in a shape of the center conductor (mask with a plurality of openings with a width of 90 μm and a length of 200 mm) is closely attached to one of the surfaces of the first film member 213, and UV light is applied for 3 minutes by a low-pressure mercury lamp to form an easy-adhesion layer 212 (FIG. 4B). A method similar to a method disclosed in Japanese Laid-open Patent Publication No. 2008-94923 can be used in this step.

(2-C) A center conductor 211 is formed by applying electroless copper plating to copper over the easy-adhesion layer 212 until the thickness is approximately 0.8 μm (FIG. 4C). A method similar to a method disclosed in Japanese Laid-open Patent Publication No. 2008-94923 can be used in this step.

(2-D) A polyethylene terephthalate film (hereinafter, called “PET film”) as a second film member 214 that is an insulating resin in an A4 size with a thickness of 40 μm is bonded to cover the center conductor 211 and the surface of the COP film around the center conductor 211 (FIG. 4D). More specifically, the center conductor 211 is placed between the first film member 213 and the second film member 214.

(2-E) A laminated body 221 is manufactured by heating and laminating at 200° C. (FIG. 4E). The PET film and the COP film are thermally welded by heating and laminating. Therefore, an adhesive is not necessary to bond the films.

(2-F) The laminated body 221 is cut parallel to the longitudinal direction of the center conductor 211, at positions 50 μm away from both ends of the center conductor 211 in the width direction. Corners of the cut laminated body 221 are trimmed in a curved shape (R face), and the shape is smoothed (FIG. 4F). As a result of this step, the laminated body 221 in a flat shape including the center conductor 211 surrounded by an internal dielectric 220 consisting of the first film member 213 and the second film member 214 is manufactured.

(2-G) The UV light is applied for 5 minutes to the entire surface of the outer periphery of the laminated body 221 to form an outer easy-adhesion layer 216 (FIG. 4G).

(2-H) The electroless copper plating method for forming the center conductor 211 in (2-C) is used to seamlessly form an outer conductor 217 with a thickness of approximately 0.8 μm throughout the entire surface of the outer periphery of the easy-adhesion layer 216 (FIG. 4H).

(2-I) A vinyl resin is applied to the entire surface of the outer periphery of the outer conductor 217 to form a protective film 218 with a thickness of approximately 10 μm (FIG. 4I). The outer shape of the manufactured shield cable 210 is a flat shape in which the thickness×width is approximately 110 μm×210 μm. The characteristic impedance of the shield cable 210 is designed to be approximately 50Ω, in consideration of the relative dielectric constant of the used film member, the sectional dimension of the created center conductor 211, and the sectional dimension of the laminated body 221.

The flexural test is conducted for the manufactured shield cable 210. As a result of the test, it is clear that the shield cable 210 is more easily bent in the thickness direction than in the width direction, and the bending anisotropy can be confirmed.

The bending test is conducted 100 times for the manufactured shield cable 210. As a result of the test, there is no break or the like in the shield cable 210, and sufficient reliability can be confirmed.

Since the COP film and the PET film with substantially the same thickness are laminated to form the internal dielectric 220, the thickness of the shield cable 210 of the present embodiment is thinner than that of a shield cable 310 of a third embodiment described later in which an internal dielectric 320 is formed only by the COP film, and the width can also be reduced.

### Third Embodiment

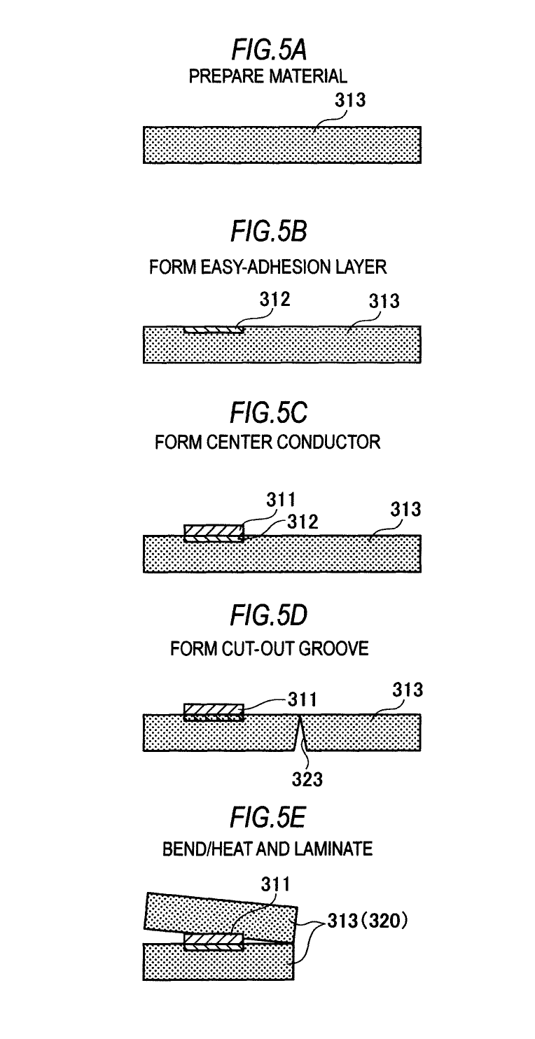

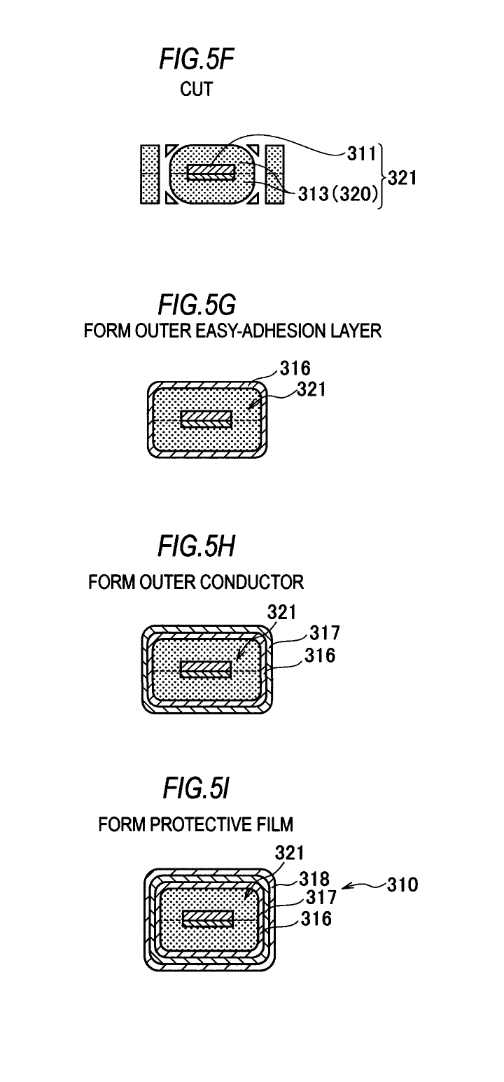

A structure and a manufacturing method of the shield cable 310 according to the third embodiment will be described with reference to FIG. 5A to 5I. FIGS. 5A to 5I are views illustrating a series of manufacturing steps of the shield cable 310. The manufacturing step in the present embodiment can be more simplified than the manufacturing step of the shield cable 210 in the second embodiment, and the number of types of material can be reduced.

(3-A) A cyclo-olefin polymer film (hereinafter, called “COP film 313”) that is an insulating resin with a thickness of 50 μm is prepared (FIG. 5A). In the present embodiment, the size of the COP film 313 is reserved so that one side in the width direction (right side in FIG. 5A) from the position for forming a center conductor 311 is larger.

(3-B) An easy-adhesion layer 312 is formed on one of the surfaces of the COP film 313 (FIG. 5B). This step is similar to the step (2-B) of the second embodiment.

(3-C) The center conductor 311 is formed by applying electroless copper plating to copper over the easy-adhesion layer 312 until the thickness is approximately 0.8 μm and further adding a copper layer of electrolytic copper plating with a thickness of approximately 1.2 μm (FIG. 5C). Since the center conductor 311 is formed approximately 1.2 μm thicker in the present embodiment, the mechanical strength can be improved, and the electric resistance can be reduced.

(3-D) A cut-out groove 323 parallel to the longitudinal direction of the center conductor 311 is formed at a position approximately 300 μm from the right edge of the center conductor 311 in the width direction in an area of the COP film 313 largely reserved in the width direction (FIG. 5D). Accuracy is not required in the depth of the cut-out groove 323, and the cut-out groove 323 may be penetrated through in the thickness direction.

(3-E) The COP film 313 is folded back in a direction where the groove width of the cut-out groove 323 is enlarged, the center conductor 311 is covered up to approximately 200 μm from the left edge of the center conductor 311 in the width direction, and the COP films 313 are bonded (FIG. 5E). More specifically, the center conductor 311 is placed between the bent COP films 313. A laminated body 321 is manufactured by heating and laminating at 260° C. The upper and lower COP films 313 are thermally welded by heating and laminating. Therefore, an adhesive is not necessary to bond the films.

In the present embodiment, the film of the COP films 313 that covers from below the center conductor 311 corresponds to a first film member, and the film that covers from above the center conductor 311 corresponds to a second film member. More specifically, the center conductor 311 is surrounded by the internal dielectric 320 consisting of only the COP films 313.

(3-F) The laminated body 321 is cut parallel to the longitudinal direction of the center conductor 311, at positions 150 μm away from both ends of the center conductor 311 in the width direction. Corners of the cut laminated body 321 are trimmed in a curved shape (R face), and the shape is smoothed (FIG. 5F).

(3-G) An outer easy-adhesion layer 316 is formed on the entire surface of the outer periphery of the laminated body 321 (FIG. 5G).

(3-H) An outer conductor 317 is seamlessly formed throughout the entire surface of the outer periphery of the easy-adhesion layer 316 (FIG. 5H). The outer conductor 317 is formed as a copper foil layer of approximately 2 μm based on the electroless copper plating method and the electrolytic copper plating method as in the formation method of the center conductor 311.

(3-I) A protective film 318 is formed on the entire surface of the outer periphery of the outer conductor 317 (FIG. 5I). A method similar to the method in the second embodiment can be used in the steps of (3-G) to (3-I). The outer shape of the manufactured shield cable 310 is a flat shape in which the thickness×width is approximately 120 μm×360 μm. The characteristic impedance of the shield cable 310 is designed to be approximately 50Ω, in consideration of the relative dielectric constant of the used film member, the sectional dimension of the created center conductor 311, and the sectional dimension of the laminated body 321.

The flexural test is conducted for the manufactured shield cable 310. As a result of the test, it is clear that the shield cable 310 is more easily bent in the thickness direction than in the width direction, and the bending anisotropy can be confirmed.

The bending test is conducted 100 times for the manufactured shield cable 310. As a result of the test, there is no break or the like in the shield cable 310, and sufficient reliability can be confirmed.

Since the COP film made of a material with a relatively small dielectric tangent is used in the shield cable 310 of the present embodiment, the transmission loss can be reduced.

### Fourth Embodiment

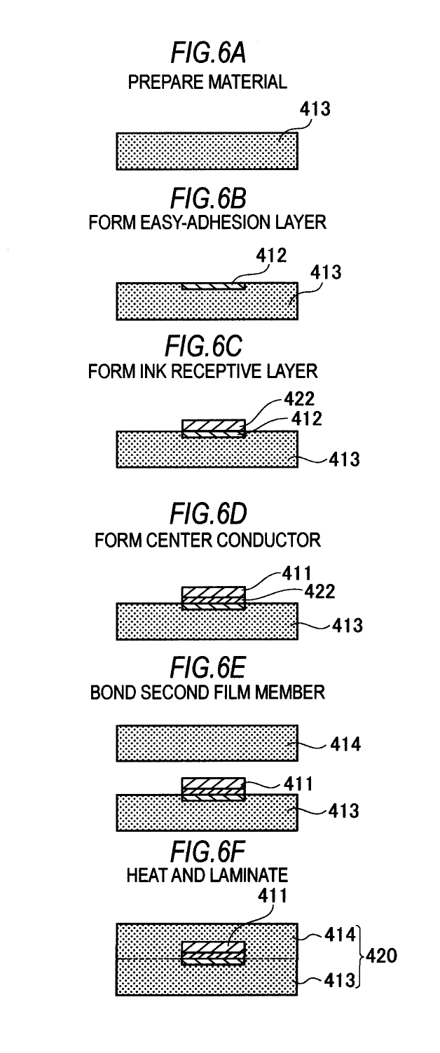

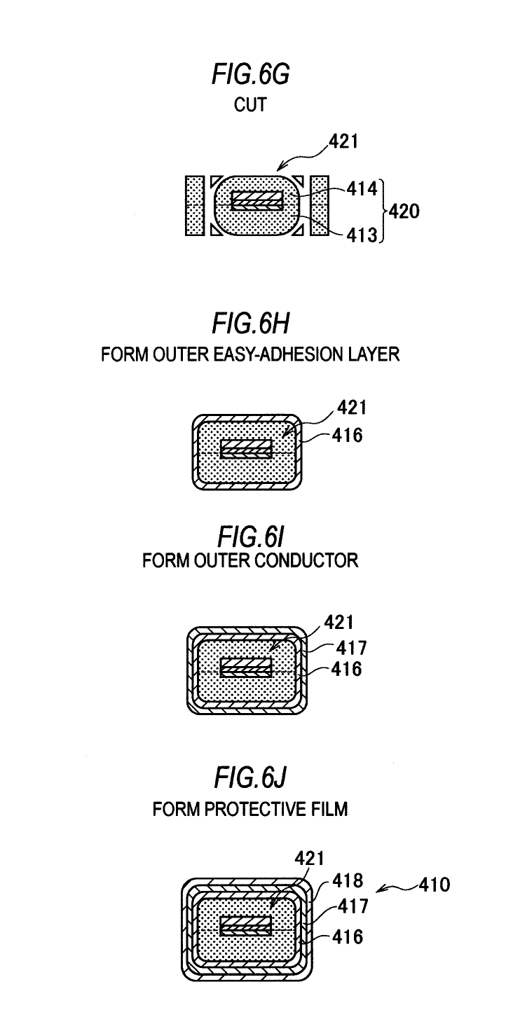

A structure and a manufacturing method of a shield cable 410 according to the fourth embodiment will be described with reference to FIG. 6A to 6J. FIGS. 6A to 6J are views illustrating a series of manufacturing steps of the shield cable 410.

(4-A) A liquid crystal polymer film that is an insulating resin in an A4 size with a thickness of 40 μm is prepared as a first film member 413 (FIG. 6A).

(4-B) A nickel exposure mask with openings in a shape of the center conductor (mask with a plurality of openings with a width of 80 μm and a length of 200 mm) is closely attached to one of the surfaces of the first film member 413, and UV light is applied for two minutes by a low-pressure mercury lamp to form an easy-adhesion layer 412 (FIG. 6B).

(4-C) An inkjet-type drawing apparatus directly draws an alumina-containing solution on the surface of the easy-adhesion layer 412 to form an ink receptive layer 422 (FIG. 6C). A method similar to a method disclosed in Japanese Laid-open Patent Publication No. 09-66664 can be used in this step. The easy-adhesion layer 412 increases the wettability with the alumina-containing solution, improves the sharpness (contour accuracy) of the drawing of the alumina-containing solution by the inkjet, and provides effective adhesiveness between the liquid crystal polymer and the ink receptive layer 422.

(4-D) The ink of the inkjet-type drawing apparatus is replaced by ink including copper nanoparticles, and a line with a width of 70 μm is drawn as a center conductor 411 on the ink receptive layer 422. An electrolytic copper plating method for applying electricity to the drawn line is used to plate a copper foil until the thickness is 5 μm to form the center conductor 411 (FIG. 6D). The ink receptive layer 422 can improve the absorbency, the homogeneous dispersion property, and the like of the applied ink including the copper nanoparticles.

(4-E) A liquid crystal polymer film as a second film member 414 in an A4 size with a thickness of 40 μm, which is the same as the first film member 413, is bonded to cover the center conductor 411 and the surface of the first film member 413 around the center conductor 411 (FIG. 6E). More specifically, the center conductor 411 is placed between the first film member 413 and the second film member 414.

(4-F) The liquid crystal polymer is thermally welded by heating and laminating at 270° C., and a laminated body 421 is manufactured (FIG. 6F).

(4-G) The laminated body 421 is cut parallel to the longitudinal direction of the center conductor 411, at positions 40 μm away from both ends of the center conductor 411 in the width direction. A trimming process is executed by placing the laminated body 421 between dies with curved shapes of the corners of the laminated body 421 and by molding the laminated body 421 at 260° C., and the shape is smoothed. As a result of this step, the laminated body 421 in a flat shape including the center conductor 411 surrounded by an internal dielectric 420 consisting of the first film member 413 and the second film member 414 is manufactured.

(4-H) The UV light is applied for five minutes to the entire surface of the outer periphery of the laminated body 421 to form an outer easy-adhesion layer 416 (FIG. 6H).

(4-I) An electroless copper plating method is used to seamlessly form a copper foil layer with a thickness of approximately 1 μm throughout the entire surface of the outer periphery of the easy-adhesion layer 416, and a copper layer based on electrolytic copper plating is further added to form an outer conductor 417 of 5 μm (FIG. 6I).

(4-J) A vinyl resin is applied to the entire surface of the outer periphery of the outer conductor 417 to form a protective film 418 with a thickness of approximately 10 μm (FIG. 6J). The outer shape of the manufactured shield cable 410 is a flat shape in which the thickness×width is approximately 100 μm×180 μm. The characteristic impedance of the shield cable 410 is designed to be approximately 50Ω, in consideration of the relative dielectric constant of the used film member, the sectional dimension of the created center conductor 411, and the sectional dimension of the laminated body 421.

The reason that the thickness of the center conductor 411 and the outer conductor 417 is 5 μm in the present embodiment is to reduce the attenuation of a transmission signal by conductor resistance, even if the length of the shield cable is much greater than approximately 200 mm that is the length in the present embodiment, or even if the shield cable is used by bending the shield cable many times and incorporating the shield cable into the electronic device.

The flexural test is conducted for the manufactured shield cable 410. Since the thickness of the center conductor 411 and the outer conductor 417 is 5 μm, the rigidity of the shield cable 410 is higher than that in the third embodiment. However, it is clear that the shield cable 410 is more easily bent in the thickness direction than in the width direction, and the bending anisotropy can be confirmed.

The bending test is conducted 100 times for the manufactured shield cable 410. As a result of the test, there is no break or the like in the shield cable 410, and sufficient reliability can be confirmed.

Since the liquid crystal polymer that is a material with a relatively small dielectric tangent is used in the shield cable 410 of the present embodiment, the transmission loss can be reduced.

The shield cables in the first to fourth embodiments have features such as the following (1) to (7).

(1) The insulating layer covers around the center conductor, and the outer conductor further covers around the insulating layer. Therefore, the shielding capability of the shield cable can be improved. Particularly, since the outer conductor is seamlessly (without seams) integrated throughout the entire surface of the outer periphery, the shielding capability can be further improved.

(2) The easy-adhesion layer is formed by the surface treatment at the bonding surface between the center conductor and the internal dielectric or between the outer conductor and the internal dielectric. Therefore, the center conductor and the internal dielectric or the outer conductor and the internal dielectric are closely attached, and the bondability can be ensured.

(3) Four corners of the flat and rectangular cross section of the laminated body are trimmed before the formation of the outer conductor.

Therefore, the damage durability improves even if a thin-film outer conductor is formed on the laminated body, and the shield capability can be maintained.

(4) The center conductor is formed by a metal thin film with a thickness of approximately 0.8 to 5 μm and a width of approximately 100 μm and is surrounded by the internal dielectric including the first film member and the second film member that are insulating organic materials with a thickness of approximately 50 μm. The outer conductor with the entire surface of the outer periphery shielded by the metal foil with a thickness of approximately 0.8 to 5 μm is formed on the laminated body, and the protective film made of an organic resin covers the outside of the outer conductor. Therefore, the shield cable can have a cross-sectional shape with a thickness of approximately 100 μm and a width of approximately 150 to several hundred μm. Therefore, the shield cable can be easily bent with mountains and valleys in the thickness direction, and the shield cable can be bent at a small radius of curvature.

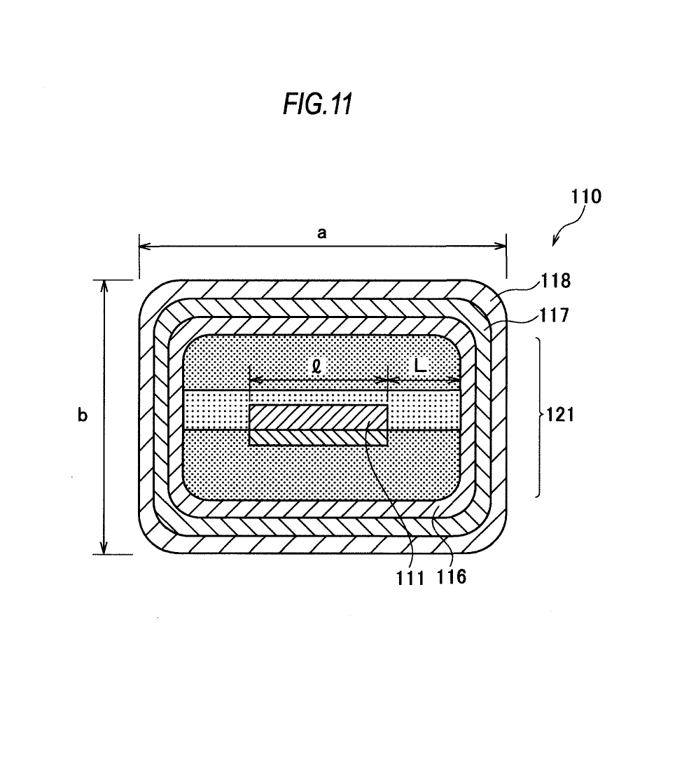

(5) An electromagnetic field simulation method or the like is used to design the flat cross-sectional shape of the shield cable in order to obtain desired characteristic impedance. For example, in the first embodiment, the thickness and the relative dielectric constant of the first film member 113, the second film member 114, and the like are emphasized, and as in the laminated body 121 that forms the inside of the shield cable 110 illustrated in FIG. 11, a length L from the end of the center conductor 111 in the width direction to the outer surface of the laminated body 121 is set from the perspective of the insulation reliability. A dimension a of the shield cable 110 in the width direction is mostly determined from the length L and a width 1 of the center conductor 111. It is suitable that a ratio a/b of the width a to thickness b of the shield cable 110 is 1.3 or greater, preferably 1.5 or greater. The flat shield cable can ensure the bending anisotropy, and the shield cable can be bent at a small radius of curvature relative to the thickness direction.

(6) The shield cable can be freely manufactured in shapes such as a crank shape and an S shape, while being bent according to the arrangement space in the housing. Therefore, when the arrangement positions of the high frequency circuit unit 4 and the antenna unit 3 are changed, the changes in the length or the bending state can be easily handled, and the degree of freedom in the design can be improved.

(7) Flexible, polymeric resin sheets that can be easily bent are suitable for the first and second film members. A liquid crystal polymer, a cyclo-olefin polymer, and the like with a little dielectric loss are suitable for the dielectric materials of the shield cables. The type of resin and the dimension, such as thickness and width, can be combined to manufacture a shield cable corresponding to required characteristic impedance.

In this way, according to the shield cable of the present embodiment, the shielding capability is improved, and the damage durability is improved. Therefore, high-quality high-frequency transmission is possible, and the reliability of communication can be ensured. Bending is possible at a small radius of curvature, and changes in the length and the bending state can be easily handled. Therefore, the shield cable can be mounted in a reduced space in the housing of a communication device.

In the embodiments described above, a known acrylic, epoxy, or silicone adhesive is used for the adhesive layer 115. Other than the method of bonding the sheet adhesive layers, a method of applying a liquid adhesive by a dispenser or by a printing method and curing the adhesive by heat or by application of ultraviolet light can be used as an application method.

Although a vinyl chloride resin is applied to the protective film that covers the outer conductor in the description of the embodiments, other insulating resins may be used. For example, solder resist ink used to manufacture a printed wiring board may be used.

### Fifth Embodiment

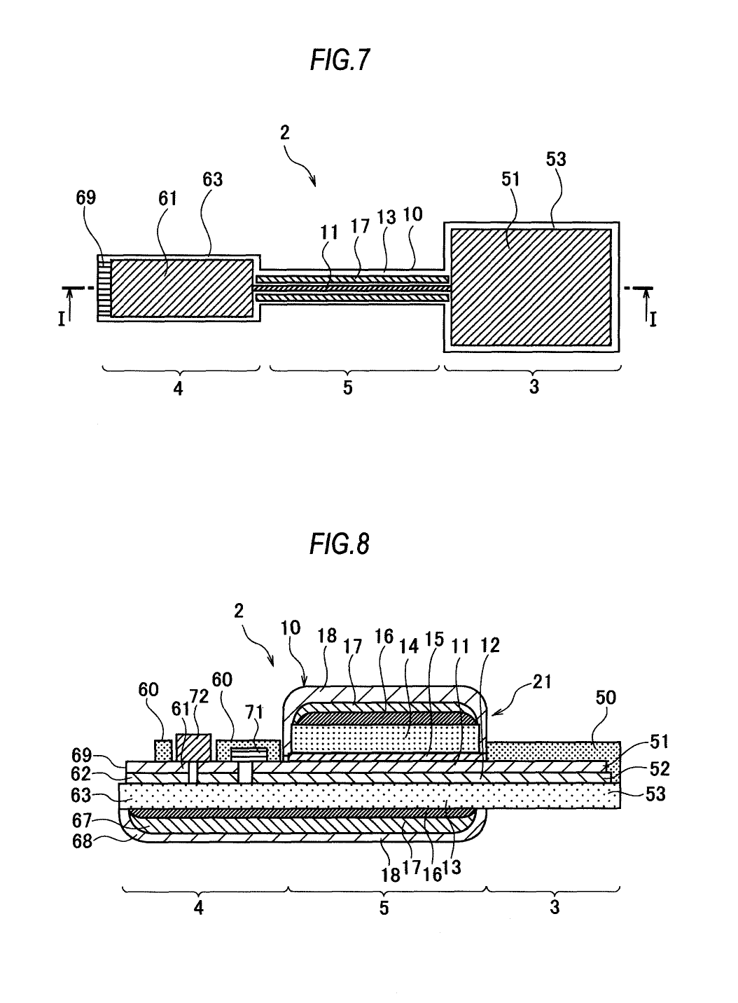

A wireless communication module 2 of the present embodiment will be described in detail with reference to FIGS. 7 and 8.

FIG. 7 is a plan view illustrating expansion of an example of the wireless communication module 2 of the present embodiment in a flat shape. Specifically, FIG. 7 is a schematic view of the wireless communication module 2 cut by a flat surface passing through a surface provided with a center conductor 11 in the transmission line unit 5, through a surface provided with an antenna element 51 described later in the antenna unit 3, and through a surface provided with a circuit conductor 61 in the high frequency circuit unit 4. One of the shield cables of the first to fourth embodiments is applied to the transmission line unit 5 illustrated in FIG. 7.

FIG. 8 is a sectional view of the wireless communication module 2 of the present embodiment cut by a I-I line passing through the center of the center conductor 11 illustrated in FIG. 7.

A shield cable 10 with a structure similar to the shield cable of the first embodiment is used in the transmission line unit 5. More specifically, the shield cable 10 includes the center conductor 11, an easy-adhesion layer 12, a first film member 13, a second film member 14, an adhesive layer 15, an outer easy-adhesion layer 16, an outer conductor 17, a protective film 18, and the like.

The shield cable 10 has the following configuration.

(A) The shield cable 10 maintains, in high quality, a high frequency signal received by the antenna unit 3 or a high frequency signal generated by the high frequency circuit unit 4 and mutually transmits the signal.

(B) The center conductor 11 that transmits the high frequency signal is formed on a first film member 13 that is a dielectric made of an organic resin, from the antenna unit 3 to the high frequency circuit unit 4. A second film member 14 that is a dielectric made of an organic resin is laminated to cover the center conductor 11.

(C) The entire surface of the outer periphery of a laminated body 21 including the first film member 13, the second film member 14, and the center conductor 11 is covered by copper foil formed as an outer conductor 17 by electroless copper plating, and in this way, the shield cable 10 has an electromagnetic wave shield function.

(D) The entire surface of the outer periphery of the shield cable 10 including both ends in the longitudinal direction is covered by a protective film 18.

A configuration, a material, and a manufacturing method of the transmission line unit 5 are as described in the first to fourth embodiments.

The antenna unit 3 has the following configuration.

(A) The antenna unit 3 emits a high frequency signal to the space as an electric wave, the high frequency signal generated by the high frequency circuit unit 4 and transmitted through the transmission line unit 5. Conversely, the antenna unit 3 receives an electric wave from the space to convert the electric wave to a high frequency signal and transmits the high frequency signal to the transmission line unit 5. Therefore, the antenna unit 3 transmits and receives electric waves.

(B) In the antenna unit 3, the first film member 13 of the shield cable 10 is extended to the antenna unit 3, and the first film member 13 functions as a support dielectric 53 that supports the antenna element 51 of the antenna unit 3. Other than this case, a support dielectric suitable for the shape of the antenna unit 3 may be prepared with the same material as the first film member 13, and the support dielectric may be bonded with the first film member 13 without cut lines. In this case, the thickness of the support dielectric may be changed, such as by using a film thicker than the first film member 13 of the shield cable 10.

(C) In FIG. 8, the first film member 13 is extended, and the support dielectric 53 is formed in a wide area of the antenna unit 3. In the antenna unit 3, the antenna element 51 is formed integrally with the center conductor 11 by a method similar to the method for the center conductor 11, on a surface on the same side as the surface provided with the center conductor 11 in the support dielectric 53. An adhesive layer 52 is formed over the support dielectric 53 here.

As a result of the formation of the antenna element 51, there is no geometric boundary at a feeding point (not illustrated) as a connection position between the center conductor 11 and the antenna element 51, which are integrally formed. Therefore, the reflection loss at the feeding point can be extremely reduced.

(D) In the antenna unit 3, an antenna protective member 50 is applied to cover the entire area of the antenna element 51 as illustrated in FIG. 8. An organic material, such as polyolefin, polystyrene, a fluorine resin, and a silicone resin, can be used for the antenna projective member 50.

(E) In the antenna unit 3, the antenna element 51 is divided into a transmission antenna and a reception antenna in some cases depending on the applications. However, the antenna originally has reversibility, and the antenna unit 3 can serve both as the transmission antenna and the reception antenna.

In this way, the support dielectric 53 of the antenna unit 3 is made of the same material as the first film member 13 of the shield cable 10. The antenna element 51 of the antenna unit 3 is made of the same material as the center conductor 11.

The high frequency circuit unit 4 has the following configuration.

(A) The high frequency circuit unit 4 modulates transmission data transmitted through the external connection electrode 69 to generate a transmission high frequency signal and transfers the generated high frequency signal to the center conductor 11 of the transmission line unit 5 to supply electricity to the antenna unit 3. Therefore, the antenna unit 3 emits an electric wave corresponding to the transmission high frequency signal. The high frequency circuit unit 4 receives, through the transmission line unit 5, a high frequency signal, which is received by the antenna unit 3 and converted from an electric wave, and demodulates the high frequency signal to acquire reception data. The reception data is transmitted to various external devices as responses, through the external connection electrode 69.

(B) In the high frequency circuit unit 4, the first film member 13 of the shield cable 10 is extended to the high frequency circuit unit 4, and the first film member 13 functions as a circuit unit dielectric 63 that supports the circuit conductor 61 of the high frequency circuit unit 4. Other than this case, a circuit unit dielectric suitable for the shape of the high frequency circuit unit 4 may be prepared with the same material as the first film member 13, and the circuit unit dielectric may be bonded with the first film member 13 without cut lines. In this case, the thickness of the circuit unit dielectric may be changed, such as by using a film thicker than the first film member 13.

(C) In FIG. 8, the first film member 13 is extended, and the circuit unit dielectric 63 is formed in a wide area of the high frequency circuit unit 4. In the high frequency circuit unit 4, the circuit conductor 61 is formed integrally with the center conductor 11 by a method similar to the method for the center conductor 11, on a surface on the same side as the surface provided with the center conductor 11 in the circuit unit dielectric 63. An adhesive layer 62 is formed over the circuit unit dielectric 63 here.

As a result of the formation of the circuit conductor 61, there is no geometric boundary at a connection position between the center conductor 11 and the circuit conductor 61, which are integrally formed. Therefore, the reflection loss at the connection position can be reduced, compared to when a coaxial cable is used for the transmission line unit 5 for the connection with the high frequency circuit unit 4 through a connector.

(D) As illustrated in FIG. 8, the high frequency circuit unit 4 is covered by a circuit protective member 60, except for an arrangement area of the electronic component 72 for mounting the circuit conductor 61 on the circuit and an area of an electrode for connecting the electronic component 72 with circuit wiring. The electronic component 71 is covered by the circuit protective member 60 applied or attached after the mounting. Other than the vinyl resin used as the protective film 18 of the shield cable 10, a solder resist or a coverlay for manufacturing a flexible wiring board can be used for the circuit protective member 60. The external connection electrode 69 can be left exposed because of its functionality.

(E) In the high frequency circuit unit 4, part of the outer conductor 17 of the shield cable 10 (part adhered below the first film member 13) is extended, and a ground conductor 67 is formed as a ground layer of the high frequency circuit unit 4 below the circuit unit dielectric 63. The formation of the ground conductor 67 is effective in reducing noise in the high frequency circuit unit 4. Instead of exposing the ground conductor 67, it is preferable to cover the ground conductor 67 by the protective film 68 formed by applying a vinyl resin or solder resist ink. It is preferable to form the protective film 68 continuously with the processing of the protective film 18 of the shield cable 10.

In this way, the circuit unit dielectric 63 of the high frequency circuit unit 4 is made of the same material as the first film member 13 of the shield cable 10. The circuit conductor 61 of the high frequency circuit unit 4 is made of the same material as the center conductor 11 of the shield cable 10. The protective film 68 of the high frequency circuit unit 4 is made of the same material as the protective film 18 of the shield cable 10. The ground conductor 67 of the high frequency circuit unit 4 is made of the same material as the outer conductor 17 of the shield cable 10.

The wireless communication module 2 of the present embodiment can be bent or twisted at the transmission line unit 5, with a small radius of curvature in the thickness direction. More specifically, folding, bending, and twisting by the transmission line unit 5 are possible while the flat shapes of the antenna unit 3 and the high frequency circuit unit 4 are maintained, and the wireless communication module 2 can be mounted on a communication device in an extremely miniaturized state.

### Sixth Embodiment

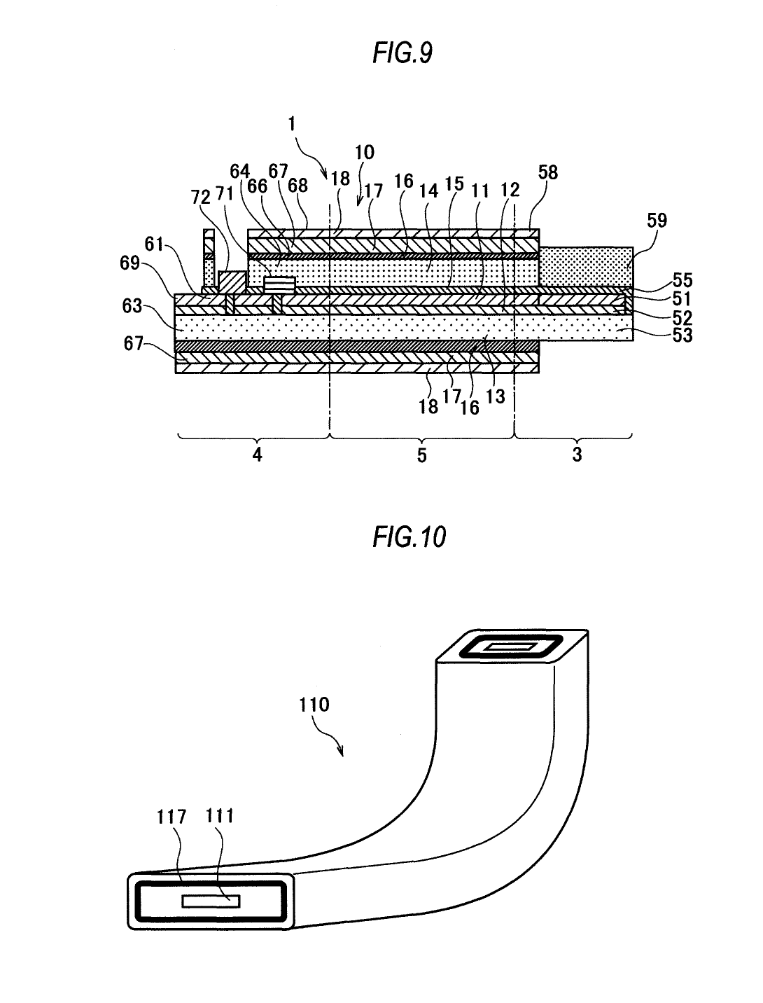

The wireless communication module 1 of the present embodiment will be described in detail with reference to FIGS. 1 and 9. In the wireless communication module 1 of the present embodiment, the same materials as in the fifth embodiment and new materials are partially used to modify the antenna unit 3 and the high frequency circuit unit 4 to improve the shielding capability of the antenna unit 3 and the high frequency circuit unit 4.

FIG. 1 is a plan view illustrating expansion of an example of the wireless communication module 1 of the present embodiment in a flat shape.

FIG. 9 is a sectional view of the wireless communication module 1 of the present embodiment cut by a II-II line passing through the center of the transmission line unit 5 illustrated in FIG. 1. The same components as in the fifth embodiment are designated with the same reference numerals, and the description will not be repeated. One of the shield cables of the first to fourth embodiments is applied to the transmission line unit 5. The shield cable 10 with a structure similar to the shield cable of the first embodiment is used here.

As illustrated in FIG. 9, the shield cable 10 is extended to the antenna unit 3 and the high frequency circuit unit 4.

In the antenna unit 3, part of the shield cable 10 is formed by being extended up to the area where the antenna element 51 is formed. More specifically, as illustrated in FIG. 1, the extended part of the shield cable 10 appears on the surface as the protective film 58. Therefore, the constituent members, such as the center conductor, the film member, and the adhesive layer, in the antenna unit 3 are covered by the outer conductor 17, the protective film 18, and the like extended from the shield cable 10. Particularly, a ground conductor as a ground layer with ground potential is formed on the antenna unit 3 by extending the outer conductor 17 of the shield cable 10 to the antenna unit 3. In this way, since the center conductor from the transmission line unit 5 to the feeding point of the antenna unit 3 is shielded, the emission characteristics of the electric wave from the antenna element 51 are excellent. Therefore, the stability of transmission and reception can be improved in the antenna unit 3.

In the high frequency circuit unit 4 of the sixth embodiment, part of the circuit conductor 61 extended from the center conductor 11 of the shield cable 10 and part of the electronic component 71 are entirely covered by the outer conductor 17, the protective film 18, and the like of the shield cable 10 extended to the high frequency circuit unit 4. Particularly, the ground conductor 67 as a ground layer with ground potential is formed on the high frequency circuit unit 4 by extending the outer conductor 17 of the shield cable 10 to the high frequency circuit unit 4. In this way, electromagnetic interference and noise can be prevented in the high frequency circuit unit 4. Connection terminals and the like of the external connection electrode 69, the electronic component 72, and the electronic component 72 are open.

For the antenna protective member 59 that covers the antenna element 51 in FIG. 9 illustrating an example of the present embodiment, it is preferable to select a material with an excellent dielectric constant according to the specifications of the antenna. A high-dielectric material can be considered from the viewpoint of the reduction in the dimension of the antenna, and a low-dielectric material can be considered from the viewpoint of the emission efficiency of the antenna. Materials with dielectric constants different from those of the second film members 114, 214, and 414 used in the shield cables of the first, second, and fourth embodiments and the second film member used in the shield cable of the third embodiment can be used for the antenna element 51 illustrated in FIG. 9 and the antenna protective member 59 that covers the antenna element 51.

For example, polyimide, nylon, and polyethylene terephthalate can be used as materials with relatively high dielectric constants.

For example, a liquid crystal polymer and a cyclo-olefin polymer can be used as materials with relatively low dielectric constants.

The specifications of the antenna are taken into account to select the materials and the thickness of the antenna protective member 59, and the antenna protective member 59 is laminated over the support dielectric 53 to cover the entire arrangement area of the antenna element 51. It is preferable to apply an adhesive layer 55 between the antenna protective member 59 and the support dielectric 53 if necessary, from the viewpoint of the adhesiveness.

In this way, the antenna protective member 59 made of a material with an appropriate dielectric constant can be formed according to the specifications of the antenna unit 3. Obviously, the second film member 14 of the transmission line unit 5 may be extended to form the antenna protective member 59, or the same material as the second film member may be used to form the antenna protective member 59 to satisfy the specifications of the antenna unit 3.

The wireless communication module 1 illustrated in FIG. 9 based on the configuration can further prevent the electromagnetic interference or noise and can improve the stability of the transmission and reception.

The wireless communication modules in the fifth and sixth embodiments have features such as the following (1) and (2).

(1) The dielectric of the shield cable used in the wireless communication module is formed by a film member made of a flexible resin that can be easily bent. The film member is thin, and the center conductor is also a thin film. Therefore, the shield cable can be formed in a planar shape, i.e. flat shape. As a result, the shield cable can be bent in the thickness direction at a small radius of curvature. If complicated bending or a shape with an extremely small radius of curvature is necessary for the shield cable, the shield cable may be mounted on the electronic device after molding the shield cable in that shape.

(2) In the wireless communication module, the center conductor is extended to integrally form the antenna element 51 of the antenna unit 3 or the circuit conductor 61 of the high frequency circuit unit 4. Or, the antenna element 51 of the antenna unit 3 or the circuit conductor 61 of the high frequency circuit unit 4 is formed in the same step as the center conductor. Therefore, the wireless communication module can have a structure with reduced dimension and thickness, and the transmission loss can be reduced.

In this way, according to the present embodiment, the wireless communication module has a structure with reduced dimension and thickness. Therefore, the degree of freedom in the arrangement in the housing of the communication device can be improved.

Although the present invention has been described along with various embodiments, the present invention is not limited to the embodiments, and changes and the like can be made within the scope of the present invention.

For example, the scope of the present invention includes not only the symmetric arrangement of the protective film 58 and the antenna element 51 of the antenna unit 3 relative to the II-II line of FIG. 1. Particularly, the scope of the present invention also includes an arrangement in which the antenna element 51 is away from the II-II line. Similarly, the area of the circuit conductor 61 and the layout of the external connection electrode 69 in the high frequency circuit unit 4 are not limited to the symmetric arrangement relative to the II-II line, and the scope of the present invention also includes an arrangement in which the external connection electrode 69 is away from the line.

In the fifth embodiment, the outer conductor 17 of the shield cable 10 is extended to the high frequency circuit unit 4 to form the ground layer on the high frequency circuit unit 4. In the sixth embodiment, the outer conductor 17 of the shield cable 10 is extended to the high frequency circuit unit 4 and the antenna unit 3 to form the ground layer. However, the arrangement is not limited to this. The outer conductor 17 of the shield cable 10 may be extended to at least one of the antenna unit 3 and the high frequency circuit unit 4 to form the ground layer.

The present invention can provide a shield cable that can ensure reliability of communication and that can be arranged in a reduced space. The present invention can also provide a wireless communication module with reduced dimension and thickness as well as a degree of freedom in the arrangement in the housing of a communication device.

What is claimed is:

1. A shield cable comprising:
a laminated body comprising: a first film member made of an insulating resin; a second film member made of an insulating resin; and a center conductor surrounded by the first film member and the second film member;
an easy-adhesion layer positioned around the laminated body;
an outer conductor positioned around the easy-adhesion layer; and
a protective film that covers around the outer conductor, wherein
the shield cable is flat when viewed in cross section.

2. The shield cable according to claim 1, wherein
corners of the laminated body are trimmed when viewed in cross section.

3. The shield cable according to claim 1, wherein
the outer conductor is seamlessly formed around the easy-adhesion layer.

4. The shield cable according to claim 1, wherein
the center conductor is positioned over an easy-adhesion layer formed at a predetermined part of the first film member.

5. The shield cable according to claim 1, wherein
the center conductor is a copper foil with a thickness of 5 μm or smaller.

6. The shield cable according to claim 1, wherein
the outer conductor is a copper foil with a thickness of 5 μm or smaller.

7. The shield cable according to claim 1, wherein
the first film member is a film made of one of polyimide, a cyclo-olefin polymer, and a liquid crystal polymer.

8. The shield cable according to claim 1, wherein
the first film member and the second film member are the same member.

9. The shield cable according to claim 1, wherein
characteristic impedance is approximately 50Ω in a straight state, and thickness is 120 μm or smaller.

10. A manufacturing method of a shield cable, the manufacturing method comprising:
a step of manufacturing a laminated body by placing a center conductor between a first film member made of an insulating resin and a second film member made of an insulating resin;
a step of forming an outer conductor around the laminated body; and
a step of covering around the outer conductor by a protective film.

11. The manufacturing method of the shield cable according to claim 10, wherein
in the step of forming the outer conductor, the outer conductor is formed over an easy-adhesion layer formed around the laminated body.

12. The manufacturing method of the shield cable according to claim 10, further comprising
a step of trimming corners of the manufactured laminated body before the step of forming the outer conductor.

13. The manufacturing method of the shield cable according to claim 10, wherein
in the step of manufacturing the laminated body, the same member is folded back to place the center conductor therebetween.

14. The manufacturing method of the shield cable according to claim 11, wherein
in the step of forming the outer conductor,
ultraviolet light is applied around the laminated body to form the easy-adhesion layer.

15. A wireless communication module comprising:
a shield cable comprising:
a laminated body comprising: a first film member made of an insulating resin; a second film member made of an insulating resin; and a center conductor surrounded by the first film member and the second film member;
an easy-adhesion layer positioned around the laminated body;
an outer conductor positioned around the easy-adhesion layer; and
a protective film that covers around the outer conductor, wherein
the shield cable is flat when viewed in cross section;
an antenna unit comprising an antenna element to which the center conductor of the shield cable is extended and connected; and
a high frequency circuit unit comprising a circuit conductor to which the center conductor of the shield cable is extended and connected.

16. The wireless communication module according to claim 15, wherein
a support dielectric provided with the antenna element and a circuit unit dielectric provided with the circuit conductor are formed by the same material as the first film member or formed by extending the first film member.

17. The wireless communication module according to claim 15, wherein
at least one of ground layers formed on the antenna unit and the high frequency circuit unit is formed by extending the outer conductor.
